(19) United States
(12) Patent Application Publication
(10) Pub. No.: US 2025/0390224 A1
(43) Pub. Date: Dec. 25, 2025

(54) ACCESS PROCESSING METHOD AND COMPUTER DEVICE

(71) Applicant: CLOUD INTELLIGENCE ASSETS HOLDING (SINGAPORE) PRIVATE LIMITED, Singapore (SG)

(72) Inventor: Xiaodong GONG, Xihu District Hangzhou, Zhejiang (CN)

(21) Appl. No.: 18/879,720

(22) PCT Filed: Jul. 26, 2023
(86) PCT No.: PCT/CN2023/109432

§ 371 Date: Dec. 27, 2024

(30) Foreign Application Priority Data
Jul. 27, 2022 (CN) 202210893995.3

(51) Int. Cl. G06F 3/06; G06F 9/455

(52) U.S. Cl. CPC G06F 3/0613; G06F 3/0659; G06F 3/067; G06F 9/455

(57) ABSTRACT

Embodiments of the present disclosure provide an access processing method and a computer device. Determining a corresponding storage node from a network storage system according to a file directory that a virtual machine requests to access; creating a first virtual drive device in a physical host and controlling the first virtual drive device to connect with the storage node; where the file directory is configured to be mounted to a target directory of the virtual machine through a second virtual drive device, so that the virtual machine accesses the file directory from the storage node through the target directory based on the first virtual drive device and the second virtual drive device; the second virtual drive device corresponding to the first virtual drive device is created in the virtual machine and synchronously obtains the file directory from the first virtual drive device.

### CROSS-REFERENCE TO RELATED APPLICATIONS

The present disclosure is a National Stage of International Application No. PCT/CN2023/109432, filed on Jul. 26, 2023, which claims the priority of Chinese Patent Application No. 202210893995.3, filed to China National Intellectual Property Administration on Jul. 27, 2022, and titled “Access processing method and computer device”, the entire contents of these applications are incorporated into the present disclosure by reference.

### TECHNICAL FIELD

Embodiments of the present disclosure relate to the technical field of data processing, in particular to an access processing method and a computer device.

### BACKGROUND

In a cloud computing scenario, a network storage system, such as an NAS (Network Attached Storage) system, is commonly used to provide a storage service for a virtual machine created in a physical host, such as a cloud server, a cloud container.

When a virtual machine accesses a network storage system, it needs to mount a remote directory requested to be accessed in the network storage system to a local directory. Because the virtual machine is located in a virtual network and the network storage system is in a physical network, the remote directory in the network storage system can be mounted to the local directory via a virtual network card of the virtual machine and a connection with the network storage system through a private network gateway. When accessing, the virtual machine also needs to forward an access request to the network storage system through the virtual network and the private network gateway.

It is necessary to convert a traffic through the private network gateway to implement accessing to the network storage system, which reduces the access efficiency.

### SUMMARY

Embodiments of the present disclosure provide an access processing method and a computer device, which are configured to solve the problem of low efficiency of accessing a network storage system by a virtual machine in the prior art.

In a first aspect, an access processing method is provided in an embodiment of the present disclosure, which includes:
determining a corresponding storage node from a network storage system according to a file directory that a virtual machine requests to access;
creating a first virtual drive device in a physical host and controlling the first virtual drive device to connect with the storage node;
where the file directory is configured to be mounted to a target directory of the virtual machine through a second virtual drive device, so that the virtual machine accesses the file directory from the storage node through the target directory based on the first virtual drive device and the second virtual drive device; the second virtual drive device corresponding to the first virtual drive device is created in the virtual machine and synchronously obtains the file directory from the first virtual drive device.

In the second aspect, an access processing method is provided in the embodiment of the present disclosure, which includes:
establishing a connection between a first virtual drive device and a storage node corresponding to a virtual machine in a network storage system, where the storage node is determined based on a file directory that the virtual machine requests to access;
synchronizing the file directory to a second virtual drive device, where the second virtual drive device corresponding to the first virtual drive device is created in the virtual machine; the file directory is configured to be mounted to a target directory of the virtual machine through the second virtual drive device;
accessing the file directory from the storage node based on an access request generated by the second virtual drive device;
where the access request is generated when the second virtual drive device receives an access instruction of the virtual machine; the access instruction is generated by the virtual machine based on an access operation on the target directory.

In a third aspect, an access processing method is provided in the embodiment of the present disclosure, which includes:
creating, in a virtual machine, a second virtual drive device which corresponds to a first virtual drive device in a physical host, where the first virtual drive device is connected with a storage node corresponding to the virtual machine; the storage node is determined based on a file directory that the virtual machine requests to access;
mounting the second virtual drive device to mount the file directory synchronously obtained by the second virtual drive device from the first virtual drive device to a target directory;
detecting an access operation on the target directory;
sending an access instruction to the second virtual drive device to access the file directory from the storage node by using the second virtual drive device and the first virtual drive device.

In the fourth aspect, an access processing method is provided in the embodiment of the present disclosure, which includes:
synchronously obtaining a file directory that a virtual machine requests to access from a first virtual drive device, where the file directory is obtained after the first virtual drive device establishes a connection with a storage node corresponding to the file directory, where the file directory is configured to be mounted to a target directory of the virtual machine;
receiving an access instruction sent by the virtual machine, and sending an access request to the first virtual drive device to access the file directory from the storage node via the first virtual drive device.

In a fifth aspect, an access processing method is provided in the embodiment of the present disclosure, which includes:
receiving a control instruction sent by a storage client end, where the control instruction includes a file directory that a virtual machine requests to access;
determining a storage node corresponding to the file directory;
feeding a storage address of the storage node back to the storage client end, where the storage address is configured to instruct that a first virtual drive device created by the storage client end in a physical host establishes a connection with the storage node.

In a sixth aspect, the embodiment of the present disclosure provides a computer device, which includes a processing component and a storage component; where the storage component stores one or more computer instructions; the one or more computer instructions are configured to be called and executed by the processing component, so as to run the access processing method according to the first aspect, according to the second aspect, according to the third aspect, according to the fourth aspect or according to the fifth aspect; where the processing component includes at least one CPU and at least one DPU; the at least one CPU is specifically configured to create and run a virtual machine, and create and run a second virtual drive device; the at least one DPU is specifically configured to run a storage client end.

In embodiments of the present disclosure, determining a corresponding storage node from a network storage system according to a file directory contained in a virtual machine creation request; creating a first virtual drive device for each virtual machine where the first virtual drive device connects with the storage node; creating, by the virtual machine, a second virtual drive device corresponding to the first virtual drive device; mounting the file directory to a target directory of the virtual machine through the second virtual drive device, so that the virtual machine accesses the file directory from the storage node through the target directory based on the first virtual drive device and the second virtual drive device. Since the physical host and the network storage system are in the same physical network, access to the network storage system can be implemented by means of the first virtual drive device and the second virtual drive device without a conversion through a gateway, thereby improving the access efficiency to the network storage system.

These aspects or other aspects of the present disclosure will be more concise and understandable in the description of the following embodiments.

### BRIEF DESCRIPTION OF DRAWINGS

In order to more clearly explain technical solutions in embodiments of the present disclosure or in the prior art, the drawings needed to be used in the description of the embodiments or the prior art will be briefly introduced below. It is evident that the accompanying drawings in the following description are some embodiments of the present disclosure, For those of ordinary skill in the art, other accompanying drawings can be obtained based on these accompanying drawings without creative effort.

FIG. 1a shows a system architecture diagram of an access processing method provided by the present disclosure.

FIG. 1b shows another system architecture diagram of an access processing method provided by the present disclosure;

FIG. 2 shows a flowchart of an embodiment of an access processing method provided by the present disclosure.

FIG. 3 shows a flowchart of another embodiment of an access processing method provided by the present disclosure.

FIG. 4 shows a flowchart of another embodiment of an access processing method provided by the present disclosure.

FIG. 5 shows a flowchart of another embodiment of an access processing method provided by the present disclosure.

FIG. 6 shows a flowchart of another embodiment of an access processing method

provided by the present disclosure.

FIG. 7 shows a signaling diagram of an access processing method provided by the present disclosure,

FIG. 8 shows a structural diagram of an embodiment of an access processing apparatus provided by the present disclosure,

FIG. 9 shows a structural diagram of another embodiment of an access processing apparatus provided by the present disclosure.

FIG. 10 shows a structural diagram of another embodiment of an access processing apparatus provided by the present disclosure.

FIG. 11 shows a structural diagram of another embodiment of an access processing apparatus provided by the present disclosure.

FIG. 12 shows a structural diagram of another embodiment of an access processing apparatus provided by the present disclosure.

FIG. 13 shows a structural diagram of one embodiment of a computer device provided by the present disclosure.

FIG. 14 shows a structural diagram of one embodiment of a computer device provided by the present disclosure.

### DESCRIPTION OF EMBODIMENTS

In order to make people in the technical field better understand a solution of the present disclosure, a technical solution in an embodiment of the present disclosure will be described clearly and completely with the accompanying drawing in the embodiment of the present disclosure,

In some processes described in the specification and claims of the present disclosure and the above drawings, there are a number of operations that appear in a specific order, but it should be clearly understood that these operations can be executed out of the order in which they appear herein or can be executed in parallel. The serial numbers of the operations, such as 101 and 102, are only used to distinguish different operations, and the serial numbers themselves do not represent any execution order. In addition, these processes may include more or fewer operations, and these operations may be executed sequentially or in parallel. It should be noted that the descriptions of “first” and “second” herein are used to distinguish different messages, devices, modules, etc., and do not represent the sequence, nor do they limit that “first” and “second” are different types.

The technical solution of the embodiment of the present disclosure can be applied to an application scenario where a virtual machine accesses a network storage system, particular to a cloud computing scenario where a cloud application accesses a network storage system, and the cloud application is deployed in a virtual machine, and in the cloud computing scenario, the virtual machine can refer to a cloud server, a cloud container and the like.

In order to facilitate the understanding of the technical solution of the present disclosure, the technical terms that may be involved in the present disclosure are firstly explained as following.

Virtual machine: refers to a complete computer system with complete hardware system functions simulated by software in a physical host and running in a completely isolated environment. The physical host is a host relative to the virtual machine, and the virtual machine is a guest relative to the physical host.

Underlay: is a physical network formed by connecting various physical devices and medium.

Overlay: is a virtual network built on the Underlay network through a network virtualization technology.

Cloud computing: the cloud computing is one of the fastest developing trends of computer technology, and it involves providing a hosting service through the network. A cloud computing environment provides computing and storage resource as a service to an end user. The end user can make a request to the provided service for processing. The processing power. of service is usually limited by configuration resource. The cloud computing is a service delivery model, which aims to achieve an on-demand network access shared configurable computing resource pool (for example, network, network bandwidth, server, processing, memory, storage, application, virtual machine and service), and these resources can be quickly deployed and published with minimal management work or interaction with a service provider.

Cloud server: is a cloud computing service provided by a cloud computing provider. The cloud computing provider can use a multi-tenant model to concentrate resources to form a resource pool that provides services for multiple tenants. A user means referring to a tenant. A cloud server that meets one's own needs can be built by purchasing resources from a cloud computing provider. The user can register a user account in the cloud computing provider, and the cloud computing provider can distinguish different users through user accounts.

NAS (Network Attached Storage): a file system with shareable access, flexible expansion, high reliability and high performance.

VFS (Virtual File System): the standard Unix system is adopted to call, read and write different file systems located on different physical media, which provides a unified operation interface and application programming interface for all kinds of file systems.

FUSE (User Space File System); refers to a file system that is completely implemented in a user mode, which realizes the docking with the kernel VFS and provides an interface for a user to write a user-mode file system.

RDMA (Remote Direct Memory Access): a technology used to solve the delay of data processing in network transmission.

CXL (Compute Express Link): an industry standard interconnection bus that provides cache consistency for a CPU, a memory, an accelerator and other devices.

VPC (Virtual Private Cloud): an Overlay network, an isolated virtual network environment built in a cloud server, which can be configured and managed by a user himself/herself. Through the VPC, the security of resource in a user's cloud can be improved and the network deployment of user can be simplified.

DPU (Data Processing Unit): a programmable special chip, which can be used as an unloading engine of CPU, release the computing power of CPU and provide a hardware acceleration function.

In the following, a technical solution in an embodiment of the present disclosure will be described clearly and completely in combination with the accompanying drawings in the embodiment of the present disclosure. It is evident that embodiments in the following description are only part of embodiments of the present disclosure, but not all of them. For those skilled in the art, all other embodiments obtained based on these embodiments of the present disclosure without creative effort are within the scope of the present disclosure.

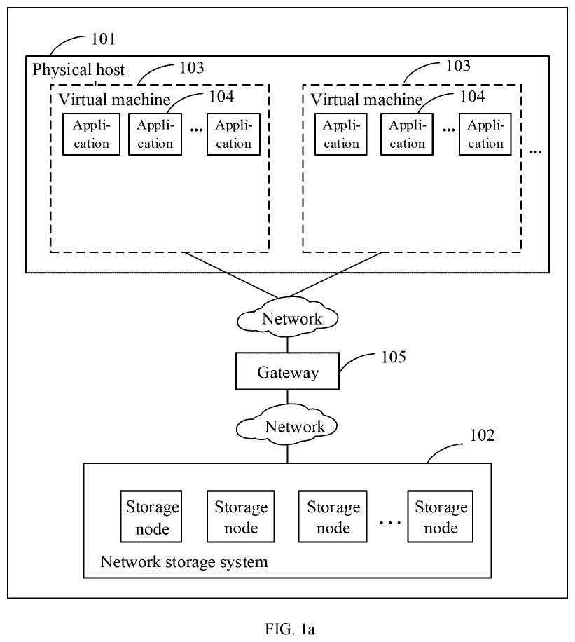

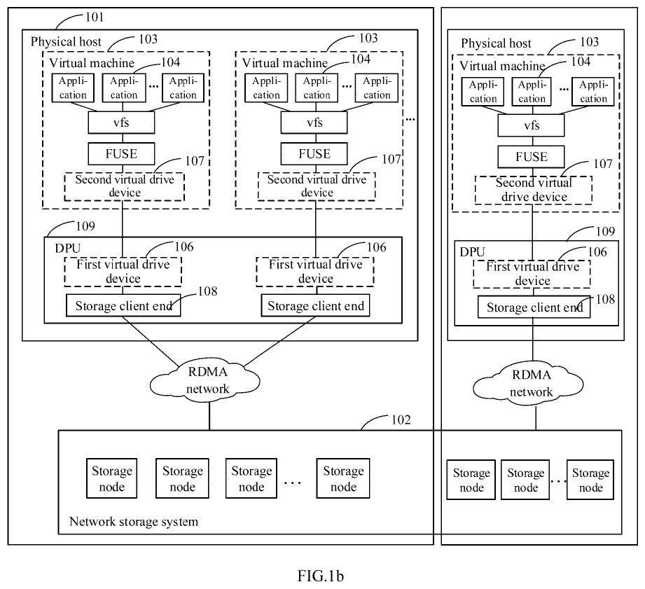

FIGS. 1a and 1b respectively shows a system architecture diagram in which the technical solution of the embodiment of the present disclosure can be applied, and the system architecture may include at least one physical host 101 and a network storage system 102.

The network storage system 102 and the physical host 101 are in the same physical network. In a cloud computing scenario, the network storage system 102 and the physical host 101 may be resources provided by a cloud computing provider.

The network storage system 102 may be a distributed system, including a plurality of storage nodes, and may also include a control node responsible for distributed computing, etc. In a practical application, the network storage system 102 may be a NAS system.

At least one virtual machine 103 can be created and run in the physical host 101, and each virtual machine 103 runs in its own virtual network to achieve the purpose of network isolation. One or more applications 104 can be built in the virtual machine 103, and the fine-grained automatic scaling of application can be realized due to the separation of calculation and data. As to requirements for storage, such as high throughput, low latency, massive instances, and elastic capacity, the network storage system is usually adopted to provide a storage service for an application. A distributed NAS system can provide tens of GB-level throughput, billion-level files, and PB-level capacity, which is very suitable for a cloud application scenario.

In the cloud computing scenario, a virtual machine can be, for example, a cloud server, a cloud container, etc. A virtual network is a VPC (Virtual Private Cloud) respectively built in the physical network, and the VPC is a private network on the cloud.

As shown in FIG. 1a, the mutual access between the physical network and the virtual network needs to be implemented through a gateway 105. As can be seen from the foregoing description, in the traditional way, if the virtual machine wants to access the network storage system, firstly, it needs to mount the remote directory of the network storage system into the local directory, which requires jumping through the gateway 105, and after the mounting is completed, it still needs to jump through the gateway 105 to access the remote directory, which leads to a decrease in the access efficiency.

In the embodiment of the present disclosure, as shown in FIG. 1b, a first virtual drive device 106 can be created for each virtual machine 103 in the physical host 101, and a second virtual drive device 107 being paired can be created in the virtual machine 103. With the help of the first virtual drive device 106 and the second virtual drive device 107, communication between the virtual machine 103 and the physical host 101 can be implemented. The first virtual drive device 106 can be connected to the network storage system 102. Since the physical host 101 and the network storage system 102 are in the same physical network, access to the network storage system can be implemented by means of the first virtual drive device 106 and the second virtual drive device 107 without a conversion through the gateway 105. Specifically, the application in the virtual machine can initiate an access operation on the second virtual drive device 107 through the VFS and the FUSE, so that access to the network storage system can be implemented through the first virtual drive device 106 and the second virtual drive device 107.

The first virtual drive device and the second virtual drive device can be implemented based on virtio-fs technology, and the virtio-fs is a file system for sharing files between the host and the guest, and communication between the host and the guest is implemented based on the FUSE protocol. Of course, the present disclosure is not limited to this.

The first virtual drive device can be created by a storage client end 108 deployed in the physical host, and can interact with a storage service end in the network storage system through the storage client end to seek or create a storage node corresponding to the file directory that the virtual machine requests to access, and instruct the first virtual drive device to establish a connection with the storage node based on a storage address of the storage node. The storage service end can be deployed in any node of the network storage system.

The storage client end can run in the CPU of the physical host, and the first virtual drive device can be specifically created in the CPU. In addition, in order to improve the data processing speed, the physical host can be configured with a DPU109, the storage client end can run in the DPU109 of the physical host, and the first virtual drive device 106 can be created in the DPU109.

A network connection can be established between the physical host and the network storage system based on a network transmission protocol, such as TCP connection, etc. When the storage client end and the first virtual drive device run in the DPU, the network connection can be established between the DPU and the network storage system. Of course, in order to improve transmission efficiency, a network communication connection can be established based on a higher-performance network transmission protocol, such as RDMA connection, so that the storage client end and the first virtual drive device can establish a higher-performance. network connection with the network storage system, etc.

The implementation details of the technical solution of the embodiment of the present disclosure are described in detail below.

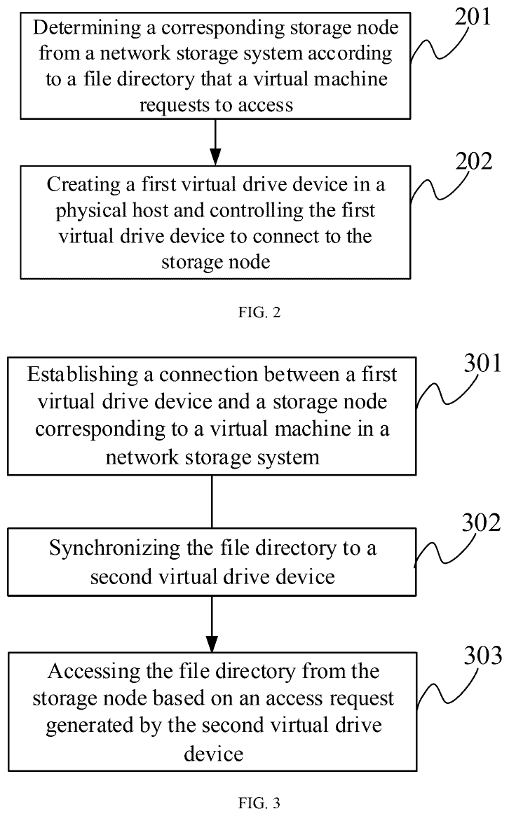

FIG. 2 is a flowchart of an embodiment of an access processing method provided by an embodiment of the present disclosure. The technical solution of this embodiment is executed by a storage client end, and the storage client end runs in a physical host. As an alternative, the storage client end can run in the CPU of the physical host. As another alternative, the physical host can be configured with a DPU, and the storage client end can run in the DPU of the physical host. The physical host can establish a connection with a network storage system, so that the storage client end can connect with a storage service end deployed in the network storage system to interact with the storage service end to implement a corresponding operation, etc. In practical application, the storage client end can be a processing process started in the physical host, and the storage service end can request to create the processing process in the physical host to provide a corresponding service for the virtual machine.

The method can include the following steps:

201: determining a corresponding storage node from a network storage system according to a file directory that a virtual machine requests to access.

The network storage system can be an NAS system; the NAS system can be composed of multiple NAS servers to form a distributed system, with each NAS server as a storage node.

In an implementation, the determining a corresponding storage node from a network. storage system according to a file directory that a virtual machine requests to access may include:
determining the corresponding storage node from the network storage system according to the file directory contained in a virtual machine creation request, where the virtual machine creation request is configured to create a corresponding virtual machine in a physical host; and the virtual machine creation request may also include a virtual machine parameter such as matching size of CPU (Central Processing Unit) and Mem (Memorizer) of the required physical host, and network bandwidth.

The virtual machine creation request can be triggered by a user via a client console or an open API, and the physical host can create the corresponding virtual machine based on the virtual machine parameter in the virtual machine creation request. The user can also specify the file directory requested to be accessed in the virtual machine creation request, and a storage client end can obtain the file directory and perform a corresponding operation, so that the file directory can be mounted and accessed at the same time when the virtual machine is created.

Of course, the file directory can also be provided by the user for a virtual machine which has been created.

202: creating a first virtual drive device in a physical host and controlling the first virtual drive device to connect to the storage node.

After the storage client end determines the storage node corresponding to the virtual machine from the network storage system, it can obtain a storage address of the storage node, such as IP address. After that, the first virtual drive device can be created in the physical host, and the storage address can be provided to the first virtual drive device, and the first virtual drive device can connect the storage node based on the storage address.

In order to further improve the access efficiency, when the storage client end runs in a DPU, the first virtual drive device can be created in the DPU of the physical host.

The file directory is configured to be mounted to a target directory of the virtual machine through a second virtual drive device, so that the virtual machine can access the file directory from the storage node through the target directory based on the first virtual drive device and the second virtual drive device. The second virtual drive device corresponding to the first virtual drive device is created in the virtual machine, and synchronously obtain the file directory from the first virtual drive device.

In this embodiment, the storage node is connected through the first virtual drive device, and since the physical host and the network storage system are in the same physical network, access to the network storage system can be implemented by means of the first virtual drive device and the second virtual drive device without a conversion through a gateway, thereby improving the access efficiency to the network storage system.

The determination of storage node can be implemented in many possible ways.

As a possible implementation, the determining a corresponding storage node from a network storage system according to a file directory that a virtual machine requests to access may include:
seeking whether there is a storage node providing the file directory from the network storage system according to the file directory that the virtual machine requests to access;
if yes, acquiring a storage address of the storage node;
if not, selecting any storage node to create the file directory and acquiring a storage address of the storage node;
where the storage address is configured to indicate that the first virtual drive device connects to the corresponding storage node.

The storage client end can send a seeking request to a storage service end, and the storage service end can seek whether there is a storage node providing the file directory. If there is, the storage service end returns a storage address of the storage node to the storage client end; otherwise, it can select any storage node to create the file directory, so as to store data in the file directory, etc. The storage client end can send a creation request to the storage service end to request the storage service end to select any storage node to create the file directory.

As another possible implementation, the determining a corresponding storage node from a network storage system according to a file directory that a virtual machine requests to access may include:
seeking whether there is a storage node corresponding to the file directory from saved metadata information according to the file directory that the virtual machine requests to access;
if yes, acquiring a storage address of the storage node;
if not, selecting any storage node to create the file directory and acquiring metadata information of the file directory.

The storage address is configured to indicate that the first virtual drive device connects to the corresponding storage node.

The storage client end can send a creation request to a storage service end, so that the storage service end can select any storage node to create the file directory, and feed metadata information of the file directory back to the storage client end. The storage client end can save. metadata information of different file directories to facilitate subsequent seeking.

The metadata information may include the storage address of the storage node corresponding to the file directory. In addition, it can also include information such as storage mode, access authority, access time and modification time of the file directory. The storage mode can include storage location in a storage medium, etc.

In the above implementations, the file directory can be created by selecting a storage node that meets a creation requirement from the network storage system. The creation requirement can be determined, for example, in combination with I/O bandwidth, network. bandwidth, rack high availability, etc.

FIG. 3 is a flowchart of an embodiment of an access processing method provided by an embodiment of the present disclosure. The technical solution of this embodiment is executed by a first virtual drive device, and the first virtual drive device can be implemented based on virtio-fs technology. The method may include the following steps:

301: establishing a connection with a storage node corresponding to a virtual machine in a network storage system.

The storage node is determined based on a file directory that the virtual machine requests to access, and the specific determination method can be found in the corresponding embodiment above, which is not repeated here.

In an implementation, the establishing a connection with a storage node corresponding to a virtual machine in a network storage system may include:
connecting a storage node corresponding to a storage address based on the storage address provided by a storage client end, where the storage address is obtained by the storage client end through seeking the network storage system according to the file directory that the virtual machine requests to access.

In order to further improve the access efficiency, in an implementation, the establishing a connection with a storage node corresponding to a virtual machine in a network storage system may include: establishing an RDMA connection with the storage node corresponding to the virtual machine in the network storage system;
the RDMA connection can be established based on an RDMA protocol, and of course, the RDMA connection can also be established by an RDMA network card, which is not limited in the present disclosure.

302: synchronizing the file directory to a second virtual drive device.

The second virtual drive device corresponding to the first virtual drive device is created in the virtual machine. The file directory is configured to be mounted to a target directory of the virtual machine via the second virtual drive device.

Step 303: accessing the file directory from the storage node based on an access request generated by the second virtual drive device.

The access request is generated when the second virtual drive device receives an

access instruction of the virtual machine. The access instruction is generated by the virtual machine based on an access operation on the target directory. The access operation on the target directory can be initiated by any application in the virtual machine.

When the first virtual drive device establishes the RDMA connection with the storage node, sending an access message to the storage node to access the file directory based on the access request generated by the second virtual drive device may include:
generating an RDMA access message based on the access request generated by the second virtual drive device;
sending the RDMA access message to the network storage system to access the file directory in the storage node,

The access request can be encapsulated as the RDMA access message according to the RDMA protocol. In addition, corresponding metadata information, such as a storage address and an access authority of the storage node, can be added to the access request to encapsulate and obtain the RDMA access message. After the RDMA access message is obtained by the network storage system, specifically it can be executed by a control node, and the access request and the corresponding metadata information can be obtained by decapsulating it. After the access request is verified based on the corresponding metadata information such as access authority and access time, the control node can send the access request to the storage node, and the storage node responds to the access request to implement an access operation on the file directory.

In this embodiment, since the physical host and the network storage system are in the same network, access to the network storage system can be implemented by means of the first virtual drive device and the second virtual drive device without a conversion through a gateway, thus improving the access efficiency to the network storage system. The RDMA connection can be established between the first virtual drive device and the storage node, which can further improve the access efficiency of the file directory.

In some embodiments, the accessing the file directory from the storage node based on an access request generated by the second virtual drive device may include:
taking a shared memory applied by the second virtual drive device in the virtual machine as a data cache, sending an access message to the storage node to access the file directory based on the access request generated by the second virtual drive device.

The access request may include a read request or a write request. When the access request is a read request, the read request may include a file identifier requested to be read and memory address of the shared memory, and the shared memory is configured for caching first data read from the file directory. When the access request is a write request, second data requested to be written into the file directory can be cached, and the write request includes the second data. Therefore, in some embodiments, the taking a shared memory applied by the second virtual drive device in the virtual machine as data cache, sending an access message to the storage node to access the file directory based on the access request generated by the second. virtual drive device may include:
when the access request generated by the second virtual drive device is a read request, sending an access message to the storage node based on the memory address of the shared memory to read first data in the file directory;
writing the first data into the shared memory corresponding to the memory address;
when the access request is a write request, acquiring second data written by the first virtual drive device from the shared memory;
sending an access message including the second data to the storage node to write the second data into the file directory.

When the access request is a read request, after the first virtual drive device writes the first data into the shared memory corresponding to the memory address, the second virtual drive device can obtain the first data from it and feed the first data back to the virtual machine.

When the access request is a write request, the second virtual drive device can cache the second data requested to be written by the virtual machine into the shared memory, so that the first virtual drive device can obtain the second data from it.

In an implementation, during writing the second data by the storage node, if the storage node reaches the storage upper limit, other storage node(s) can be added to continue writing the second data, and the selection of other storage node(s) can be combined with the creation requirement, such as taking I/O bandwidth, network bandwidth, rack high availability, etc., into consideration.

The shared memory can be accessed by both the first virtual drive device and the second virtual drive device. The access mode of the shared memory can be implemented in various ways.

As an alternative, after the first virtual drive device establishes the connection with the storage node, it may further include:
applying for a memory address and mapping the memory address to the shared memory to access the shared memory based on the memory address.

As another alternative, a memory address of the shared memory can be acquired through a cache coherence bus, such as the CXL, so as to access the shared memory.

In some embodiments, the method may further include:
obtaining the metadata information of the file directory from the storage node.

The accessing the file directory from the storage node based on an access request generated by the second virtual drive device may include:
sending an access message to the network storage system according to metadata information to access the file directory in the storage node, based on the access request generated by the second virtual drive device.

The access message may be generated by encapsulating the metadata information with the access request, and the access message may be an RDMA message.

In addition, the first virtual drive device can also receive a response message fed back by the storage node and send the response message to the virtual machine via the second virtual drive device. The response message is configured to confirm that the response to the access request is successful. When the access request is a read request, the response message may also include the second data requested to be read. The response message can be written into the shared memory by the first virtual drive device, and the second virtual drive device can obtain the response message from the shared memory and feed it back to the virtual machine.

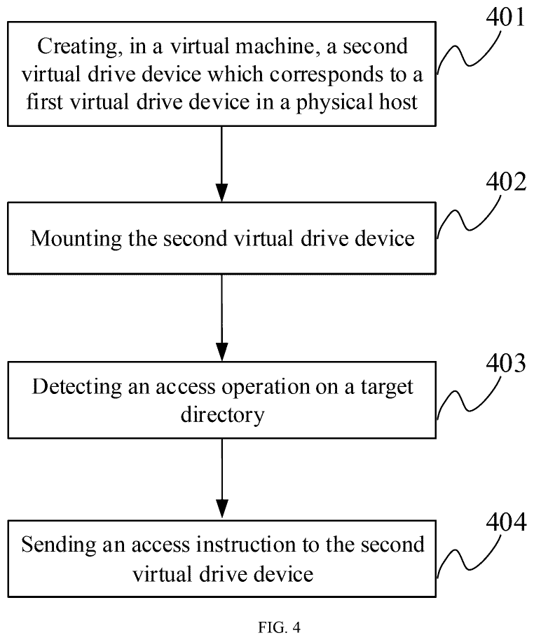

FIG. 4 is a flowchart of an embodiment of an access processing method provided by an embodiment of the present disclosure, which is executed by a virtual machine in this embodiment, and the method may include the following steps:

401: creating, in a virtual machine, a second virtual drive device which corresponds to a first virtual drive device in a physical host.

The first virtual drive device is connected with a storage node corresponding to the virtual machine. The storage node is determined based on a file directory that the virtual machine requests to access.

The creating, in a virtual machine, a second virtual drive device which corresponds to a first virtual drive device in a physical host may include:
in response to a startup instruction, creating the corresponding second virtual drive device when the first virtual drive device is detected in the physical host.

The virtual machine can be configured with an ACPI (Advanced Configuration and Power Management Interface), and the physical host can be detected in the first virtual drive device through the ACPI.

A corresponding first virtual drive device and a corresponding second virtual drive device can be created for each virtual machine. After the second virtual drive device is created in the virtual machine, the second virtual drive device can establish a connection with the first virtual drive device to implement communication.

402: mounting the second virtual drive device to mount the file directory synchronously obtained by the second virtual drive device from the first virtual drive device to a target directory.

The mounting the second virtual drive device is equivalent to assigning a drive letter to the second virtual drive device, so that the file directory can be mounted to the target directory. The target directory is any local directory in the virtual machine. The mounting operation can be implemented by a mounting command, such as “mount-t virtio fs myfs/mnt/data”. The virtio fs represents the second virtual drive device, the myfs represents the file directory, and the/data represents a local target directory.

The mounting command may be received to mount the second virtual drive device, to mount the file directory synchronously obtained by the second virtual drive device from the first virtual drive device to the target directory.

The mounting command may be triggered by a user or generated after the virtual machine creates the second virtual drive device.

If an application in the virtual machine wants to access the file directory, it needs to be implemented through a VES system, so the mounting the second virtual drive device can be through the VES and the FUSE, so as to mount the file directory synchronously obtained by the second virtual drive device from the first virtual drive device to the target directory.

403: detecting an access operation on a target directory.

The access operation is initiated by an application in the virtual machine.

404: sending an access instruction to the second virtual drive device, to access the file directory from the storage node by using the second virtual drive device and the first virtual drive device.

The specific access process has been described in detail in the previous corresponding embodiment, and will not be repeated here.

In this embodiment, a virtual machine creates a second virtual drive device corresponding to a detected first virtual drive device, and after a file directory is mounted to a target directory by the second virtual drive device, the virtual machine can access the file directory from a storage node through the second virtual drive device and the first virtual drive device. Since the physical host and the network storage system are in the same network, access to the network storage system can be implemented by means of the first virtual drive device. and the second virtual drive device without a conversion through a gateway, thus improving the access efficiency to the network storage system.

FIG. 5 is a flowchart of an embodiment of an access processing method provided by an embodiment of the present disclosure, which is executed by a second virtual drive device in the technical solution of this embodiment, and the method may include the following steps:

501: synchronously obtaining a file directory that a virtual machine requests to access from a first virtual drive device.

The file directory is obtained after the first virtual drive device establishes a connection with a storage node corresponding to the file directory.

The file directory is configured to be mounted to a target directory of the virtual machine.

The second virtual drive device may first establish a connection with the first virtual drive device, so before step 501, it may further include: establishing a connection with the first virtual drive device.

502: receiving an access instruction sent by the virtual machine, and sending an access request to the first virtual drive device to access the file directory from the storage node via the first virtual drive device.

In some embodiments, the method may further include:
applying for a shared memory in the virtual machine.

The sending an access request to the first virtual drive device may include:
taking the shared memory as a data cache and sending the access request to the first virtual drive device.

In some embodiments, the taking the shared memory as a data cache and sending the access request to the first virtual drive device may include:
when the access instruction is a read instruction, sending a read request to the first virtual drive device, so that the first virtual drive device can read first data from the file directory in the storage node and write the first data into the shared memory;
when the access instruction is a write instruction, writing second data into the shared memory, and sending a write request to the first virtual drive device, so that the first virtual drive device obtains the second data from the shared memory and write the second data into the file directory.

The specific contents of the steps related to this embodiment have been described in detail in the previous embodiments, and the specific execution steps and contents can refer to the description of the previous embodiments, so they are not repeated here.

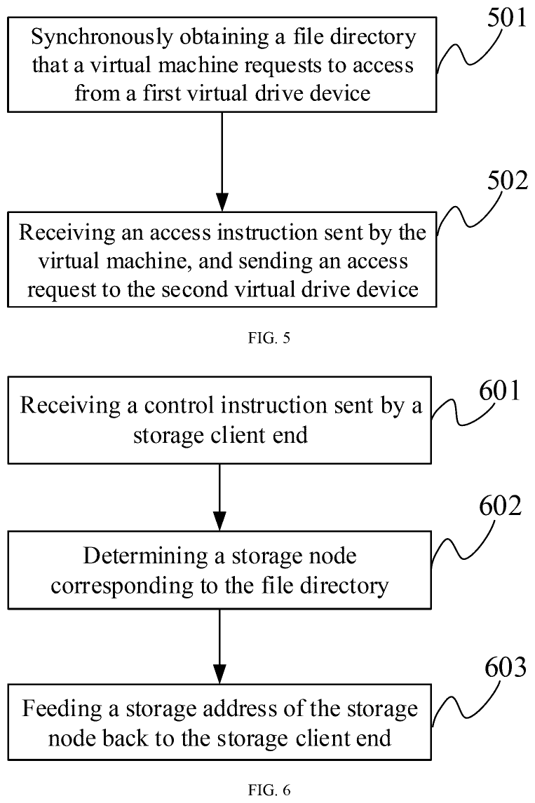

FIG. 6 is a flowchart of an embodiment of an access processing method provided by an embodiment of the present disclosure. The technical solution of this embodiment is applied to a network storage system and executed by a storage service end. The method may include the following steps:

601: receiving a control instruction sent by a storage client end.

The control instruction includes a file directory that a virtual machine requests to access.

602: determining a storage node corresponding to the file directory.

In an implementation, the determining a storage node corresponding to the file directory includes:
seeking whether there is a storage node providing the file directory;
if yes, performing the operation of step 603; if not, selecting a storage node that meets a creation requirement and creating the file directory, and then performing the operation. of step 603.

In another implementation, the control instruction may be generated when the storage client end determines that the file directory does not exist in the network storage system.

The determining a storage node corresponding to the file directory includes:
selecting a storage node that meets a creation requirement and creating the file directory.

603: feeding a storage address of the storage node back to the storage client end. The storage address is configured to instruct that a first virtual drive device created by the storage client end in a physical host establishes a connection with the storage node.

In some embodiments, the method further includes:
feeding metadata information of the file directory back to the storage client end.

The metadata information can be configured for seeking whether the file directory exists in the network storage system. In addition, it can also be configured to seek access authority, access time and modification time of the file directory, etc.

The specific contents of the steps related to this embodiment have been described in detail in the previous embodiments, and the specific execution steps and contents can refer to the description of the previous embodiments, so they are not repeated here.

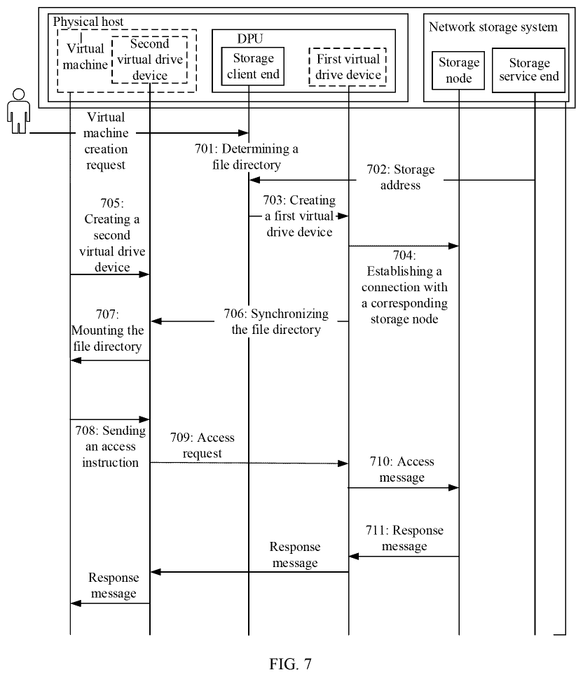

In order to facilitate the understanding of technical solutions of embodiments of the present disclosure, the technical solutions of embodiments of the present disclosure are described below in combination with the signaling diagram shown in FIG. 7. The access processing method shown in FIG. 7 may include the following steps:

701: determining, by a storage client end, a file directory requested to be accessed according to a virtual machine creation request triggered by a user.

A physical host can receive the virtual machine creation request and start a storage client end in a DPU. The virtual machine creation request includes the file directory requested to be accessed. Therefore, the storage client end can determine the file directory requested to be accessed based on the virtual machine creation request.

702: determining, by the storage client end, a storage address of a storage node corresponding to the file directory.

The storage client end can interact with a storage service end to determine the storage address of the storage node corresponding to the file directory in the network storage system. The specific determination method of the storage node can refer to the description in the corresponding embodiments above, and will not be described here.

The DPU can establish an RDMA connection with the network storage system, so the storage client end can communicate with the storage service end based on the RDMA connection.

703: creating, by the storage client end, a first virtual drive device in the physical host.

Alternatively, the first virtual drive device may be created in the DPU.

704: establishing a connection between the first virtual drive device and the corresponding storage node based on the storage address.

In addition, the first virtual drive device can also acquire, from the storage node, metadata information of the file directory, etc.

705: in response to a startup instruction, creating, by the virtual machine, in the physical host, a second virtual drive device corresponding to the first virtual drive device.

706: synchronously obtaining, by the second virtual drive device, the file directory from the first virtual drive device.

707: mounting, by the virtual machine, the second virtual drive device to mount the file directory to a target directory.

708; detecting, by the virtual machine, an access operation on the target directory and sending an access instruction to the second virtual drive device.

709: sending, by the second virtual drive device, an access request to the first virtual drive device based on the access instruction.

710: sending, by the first virtual drive device, an access message to the network storage system based on the access request, so as to access the file directory in the storage node.

The access message can be an RDMA message.

711: generating, by the storage node, a response message based on the access message, and feeding the response message back to the virtual machine via the second virtual drive device and the first virtual drive device.

The specific contents of the steps related to this embodiment have been described in detail in the previous embodiments, and the specific execution steps and contents can refer to the description of the previous embodiments, so they are not repeated here.

In this embodiment, a storage client end can create a first virtual drive device in a DPU, and the first virtual drive device can establish an RDMA connection with a corresponding storage node based on a storage address, and then a virtual machine creates in the physical host a second virtual drive device corresponding to the detected first virtual drive device, and the second virtual drive device mounts a file directory to a target directory, so that the virtual machine can access the file directory from the storage node through the second virtual drive device and the first virtual drive device. Because the physical host and the network storage system are in the same physical network, access to the network storage system can be implemented by means of the first virtual drive device and the second virtual drive device without a conversion through a gateway, thus improving the access efficiency to the network storage system.

FIG. 8 is a structural diagram of an embodiment of an access processing apparatus provided by the present disclosure, which can be implemented as the storage client end described above, and may include:
a first node determining module 801, configured to determine a corresponding storage node from a network storage system according to a file directory that a virtual machine requests to access;
a first device creation module 802, configured to create a first virtual drive device in a physical host and control the first virtual drive device to connect with the storage node.

The file directory is configured to be mounted to a target directory of the virtual machine through a second virtual drive device, so that the virtual machine accesses the file directory from the storage node through the target directory based on the first virtual drive device and the second virtual drive device. The second virtual drive device corresponding to the first virtual drive device is created in the virtual machine, and the second virtual drive device synchronously obtains the file directory from the first virtual drive device.

In some embodiments, the first node determining module 801 can be specifically configured to determine the corresponding storage node from the network storage system according to the file directory contained in a virtual machine creation request. The virtual machine creation request is configured to create a corresponding virtual machine in the physical host.

In some embodiments, the first node determining module 801 can be specifically configured to seek whether there is a storage node providing the file directory from the network storage system according to the file directory that the virtual machine requests to access; if yes, acquire a storage address of the storage node; if not, select any storage node to create the file directory and acquire a storage address of the storage node. The storage address is configured to indicate that the first virtual drive device connects to the corresponding storage node.

In some embodiments, when the first device creation module 802 creates the first virtual drive device in the physical host, the first device creation module 802 can be specifically configured to create the first virtual drive device in a data processing unit DPU of the physical host.

In some embodiments, the network storage system may be a network attached storage NAS system.

In some embodiments, the first node determining module 801 can be specifically configured to seek whether there is a storage node corresponding to the file directory from saved metadata information according to the file directory that the virtual machine requests to access; if yes, acquire a storage address of the storage node; if not, select any storage node to create the file directory and acquire metadata information of the file directory.

The access processing apparatus described in FIG. 8 can execute the access processing method described in the embodiment shown in FIG. 2, and its implementation principle and technical effect will not be repeated. The specific way in which each module and unit of the access processing apparatus in the above embodiment performs operations has been described in detail in embodiments of the related method, and will not be described in detail here.

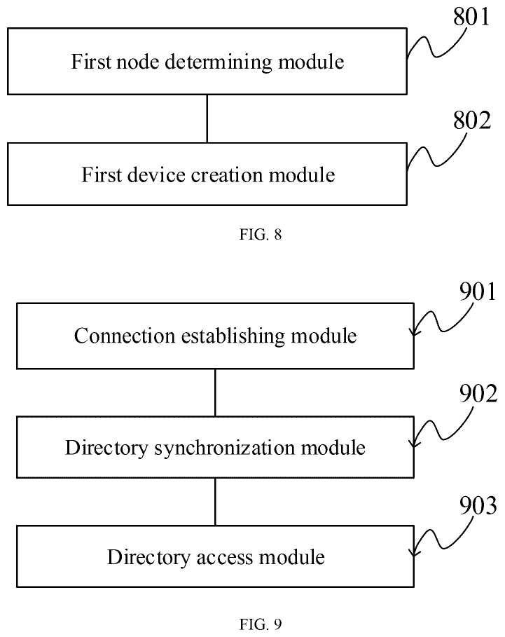

FIG. 9 is a structural diagram of another embodiment of an access processing apparatus provided by the present disclosure, which can be implemented as the first virtual drive device described above, and which may include:
a connection establishing module 901, configured to establish a connection between a first virtual drive device and a storage node corresponding to a virtual machine in a network storage system, where the storage node is determined based on a file directory that the virtual machine requests to access;
a directory synchronization module 902, configured to synchronize the file directory to a second virtual drive device, where the second virtual drive device corresponding to the first virtual drive device is created in the virtual machine; the file directory is configured to be mounted to a target directory of the virtual machine via the second virtual drive device;
a directory access module 903, configured to access the file directory from the storage node based on an access request generated by the second virtual drive device.

The access request can be generated when the second virtual drive device receives an access instruction of the virtual machine. The access instruction may be generated by the virtual machine based on an access operation on the target directory.

In some embodiments, the connection establishing module 901 can be specifically configured to connect a storage node corresponding to a storage address based on the storage address provided by a storage client end. The storage address is obtained by the storage client end through seeking the network storage system according to the file directory that the virtual machine requests to access.

In some embodiments, the apparatus may further include an information acquisition module configured to acquire metadata information of the file directory from the storage node. The directory access module 903 can be specifically configured to send an access message to the network storage system according to the metadata information based on the access request generated by the second virtual drive device, so as to access the file directory in the storage node.

In some embodiments, the connection establishing module 901 can be specifically configured to establish an RDMA connection with the storage node corresponding to the virtual machine in the network storage system. The accessing the file directory from the storage node based on an access request generated by the second virtual drive device includes generating an RDMA access message based on the access request generated by the second virtual drive device; sending the RDMA access message to the network storage system to access the file directory in the storage node.

In some embodiments, the directory access module 903 can be specifically configured to take a shared memory applied by the second virtual drive device in the virtual machine as a data cache, and send an access message to the storage node to access the file directory based on the access request generated by the second virtual drive device. The take a shared memory applied by the second virtual drive device in the virtual machine as a data cache, and send an access message to the storage node to access the file directory based on the access request generated by the second virtual drive device may include: when the access request generated by the second virtual drive device is a read request, send an access message to the storage node based on memory address of the shared memory, to read first data in the file directory, write the first data into the shared memory corresponding to the memory address, when the access request is a write request, acquire second data written by the first virtual drive device from the shared memory, send an access message including the second data to the storage node, to write the second data into the file directory.

In some embodiments, the apparatus may further include an address acquisition module, which is configured to: apply for a memory address and map the memory address to the shared memory to access the shared memory based on the memory address; or, acquire a memory address of the shared memory through a cache coherence bus.

The access processing apparatus described in FIG. 9 can execute the access processing method described in the embodiment shown in FIG. 3, and its implementation principle and technical effect will not be repeated. The specific way in which each module and. unit of the access processing apparatus in the above embodiment performs operations has been described in detail in embodiments of the related method, and will not be described in detail here

FIG. 10 is a structural diagram of another embodiment of an access processing apparatus provided by the present disclosure, which can be implemented as the virtual machine described above, and may include:
a second device creation module 1001, configured to create, in a virtual machine, a second virtual drive device which corresponds to a first virtual drive device in a physical host. The first virtual drive device is connected with a storage node corresponding to the virtual machine. The storage node is determined based on a file directory that the virtual machine requests to access;
a device mounting module 1002, configured to mount the second virtual drive device, to mount the file directory synchronously obtained by the second virtual drive device from the first virtual drive device to a target directory;
an operation detection module 1003, configured to detect an access operation on the target directory:
an instruction sending module 1004, configured to send an access instruction to the second virtual drive device to access the file directory from the storage node by using the second virtual drive device and the first virtual drive device.

In some embodiments, the second device creation module 1001 can be specifically configured to, in response to a startup instruction, create the corresponding second virtual drive device when the first virtual drive device is detected in the physical host.

In some embodiments, when the device mounting module 1002 mounts the second virtual drive device, the device mounting module can be specifically configured to receive a mounting command and mount the second virtual drive device, to mount the file directory synchronously obtained by the second virtual drive device from the first virtual drive device to the target directory.

In some embodiments, the device mounting module 1002 can be specifically configured to mount the second virtual drive device through a VFS system based on a FUSE. protocol, to mount the file directory synchronously obtained by the second virtual drive device from the first virtual drive device to the target directory.

The access processing apparatus described in FIG. 10 can execute the access processing method described in the embodiment shown in FIG. 4, and its implementation principle and technical effect will not be repeated. The specific way in which each module and unit of the access processing apparatus in the above embodiment performs operations has been described in detail in embodiments of the related method, and will not be described in detail here.

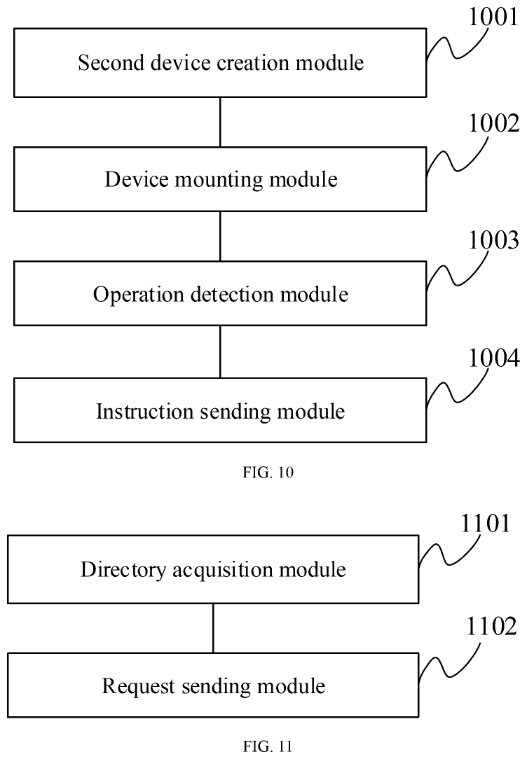

FIG. 11 is a structural diagram of another embodiment of an access processing apparatus provided by the present disclosure, which can be implemented as the second virtual drive device described above, and which may include:
a directory acquisition module 1101, configured to synchronously obtain a file directory that a virtual machine requests to access from a first virtual drive device. The file directory is obtained after the first virtual drive device establishes a connection with a storage node corresponding to the file directory. The file directory is configured to be mounted to a target directory of the virtual machine.
a request sending module 1102, configured to receive an access instruction sent by the virtual machine and send an access request to the first virtual drive device to access the file directory from the storage node via the first virtual drive device.

In some embodiments, the apparatus may further include a memory application module, which is configured to apply for a shared memory in the virtual machine. After the request sending module 1102 receives the access instruction sent by the virtual machine, the request sending module 1102 can be specifically configured to take the shared memory as a data cache and send an access request to the first virtual drive device.

In some embodiments, the request sending module 1102 can be specifically configured to take the shared memory as a data cache and send an access request to the first virtual drive device, when the access instruction is a read instruction, send a read request to the first virtual drive device, so that the first virtual drive device can read first data from the file directory in the storage node and write the first data into the shared memory; when the access instruction is a write instruction, write second data into the shared memory, and send a write request to the first virtual drive device, so that the first virtual drive device obtains the second data from the shared memory and write the second data into the file directory.

The access processing apparatus described in FIG. 11 can execute the access processing method described in the embodiment shown in FIG. 5, and its implementation principle and technical effect will not be repeated. The specific way in which each module and unit of the access processing apparatus in the above embodiment performs operations has been described in detail in embodiments of the related method, and will not be described in detail here.

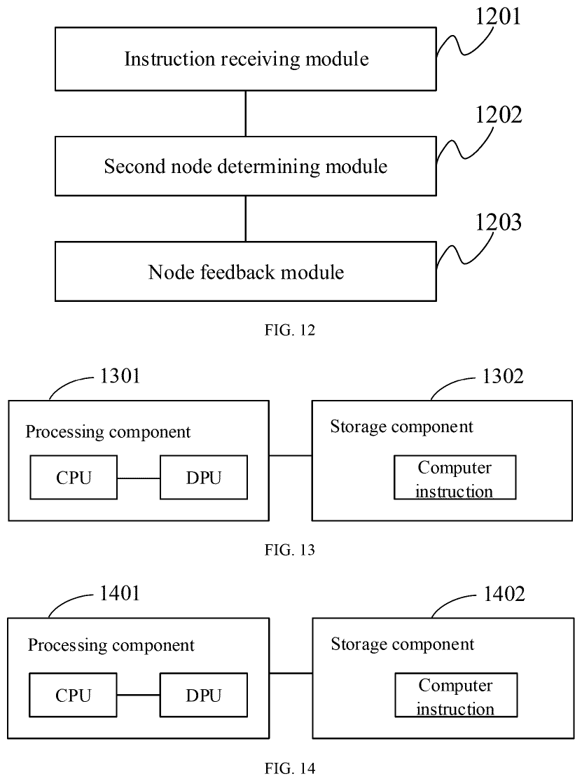

FIG. 12 is a structural diagram of another embodiment of an access processing apparatus provided by the present disclosure, which can be implemented as the network storage system described above, and may include:
an instruction receiving module 1201, configured to receive a control instruction sent by a storage client end; the control instruction includes a file directory that a virtual machine requests to access.
a second node determining module 1202, configured to determine a storage node corresponding to the file directory.
a node feedback module 1203, configured to feed a storage address of the storage node back to the storage client end; the storage address is configured to instruct that a first virtual drive device created by the storage client end in a physical host establishes a connection with the storage node.

In some embodiments, the second node determining module 1202 can be specifically configured to seek whether there is a storage node providing the file directory; If not, select a storage node that meets a creation requirement and create the file directory.

In some embodiments, the control instruction may be generated when the storage client end determines that the file directory does not exist in the network storage system. The second node determining module 1202 can be specifically configured to select a storage node that meets a creation requirement and create the file directory. The apparatus may further include an information feedback module configured to feed metadata information of the file directory back to the storage client end. The metadata information is configured to seek whether the file directory exists in the network storage system.

The access processing apparatus described in FIG. 12 can execute the access processing method described in the embodiment shown in FIG. 6, and its implementation principle and technical effect will not be repeated. The specific way in which each module and unit of the access processing apparatus in the above embodiment performs operations has been described in detail in embodiments of the related method, and will not be described in detail here.

FIG. 13 is a structural diagram of one embodiment of a computer device provided by the present disclosure, which may include a processing component 1301 and a storage component 1302. The storage component 1302 stores one or more computer instructions. The one or more computer instructions are configured to be called and executed by the processing component 1301, so as to run a storage client end to implement the access processing method of the embodiment shown in FIG. 2, and to create and run a first virtual drive device to implement the access processing method of the embodiment shown in FIG. 3, and to create and run a virtual machine to implement the access processing method of the embodiment shown in FIG. 4, and to create and run a second virtual drive device to implement the access processing method of the embodiment shown in FIG. 5.

The processing component can include at least one CPU and at least one DPU.

The at least one CPU can be specifically configured to create and run a virtual machine, and create and run a second virtual drive device.

The at least one DPU can be specifically configured to run a storage client end.

Of course, the computer device can also include other components, such as an input/output interface, a display component, a communication component and so on.

The input/output interface can provide an interface between the processing component and a peripheral interface module, and the peripheral interface module can be an output device, an input device, etc. The communication component is configured to facilitate wired or wireless communication between the computing device and other devices, etc.

The storage component is configured to store various types of data to support an operation at a terminal. The storage component can be implemented by any type of volatile or nonvolatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The display assembly can be an electroluminescent (EL) element, a liquid crystal display or a micro display with similar structure, or a laser scanning display with direct retina display or the like.

It should be noted that the above computing device can be a physical device or an elastic computing host provided by a cloud computing platform, etc. It can be implemented as a distributed cluster composed of multiple servers or terminal devices, or as a single server or a terminal device.

In addition, the embodiment of the present disclosure also provides a computer-readable storage medium, which stores a computer program. When the computer program is executed by a computer, the access processing method of the embodiment shown in FIG. 2, or the access processing method of the embodiment shown in FIG. 3, or the access processing method of the embodiment shown in FIG. 4, or the access processing method of the embodiment shown in FIG. 5 can be implemented. The computer-readable medium can be included in the computer device described in the above embodiment. It can also exist alone without being assembled into the computer device.

In addition, the embodiment of the present disclosure also provides a computer program product, which includes a computer program carried on a computer-readable storage medium. When the computer program is executed by a computer, the access processing method of the embodiment shown in FIG. 2, or the access processing method of the embodiment shown in FIG. 3, or the access processing method of the embodiment shown in FIG. 4, or the access processing method of the embodiment shown in FIG. 5 can be implemented. In such an embodiment, the computer program may be downloaded and installed from the network, and/or installed from a removable medium. When executed by a processor, the computer program performs various functions defined in the system of the present disclosure.

FIG. 14 is a structural diagram of one embodiment of a computer device provided by the present disclosure, which may include a processing component 1401 and a storage component 1402. The storage component 1402 stores one or more computer instructions. The one or more computer instructions are configured to be called and executed by the processing component 1401 to implement the access processing method of the embodiment shown in FIG. 6.

Of course, the computer device can also include other components, such as an input/output interface, a display component, a communication component and so on.

The input/output interface can provide an interface between the processing component and a peripheral interface module, and the peripheral interface module can be an output device, an input device, etc. The communication component is configured to facilitate wired or wireless communication between the computing device and other devices, etc.

The processing component may include one or more processors to execute the computer instruction to complete all or part of the steps in the above method. Of course, the processing component can also be implemented as one or more application-specific integrated circuits (ASIC), digital signal processors (DSP), digital signal processing devices (DSPD), programmable logic devices (PLD), field programmable gate arrays (FPGA), controllers, microcontrollers, microprocessors or other electronic components etc., so as to execute the above methods.

The storage component is configured to store various types of data to support an operation at a terminal. The storage component can be implemented by any type of volatile or nonvolatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The display assembly can be an electroluminescent (EL) element, a liquid crystal display or a micro display with similar structure, or a laser scanning display with direct retina display or the like.

It should be noted that the above computing device can be a physical device or an elastic computing host provided by a cloud computing platform, etc. It can be implemented as a distributed cluster composed of multiple servers or terminal devices, or as a single server or a terminal device.

In addition, the embodiment of the present disclosure also provides a computer-readable storage medium, which stores a computer program. When the computer program is executed by a computer, the access processing method of the embodiment shown in FIG. 6 can be implemented. The computer-readable medium can be included in the computer device described in the above embodiment. It can also exist alone without being assembled into the computer device.

In addition, the embodiment of the present disclosure also provides a computer program product, which includes a computer program carried on a computer-readable storage medium, and when the computer program is executed by a computer, the data access method as shown in the embodiment of FIG. 6 can be implemented. In such an embodiment, the computer program may be downloaded and installed from the network, and/or installed from a removable medium. When executed by a processor, the computer program performs various functions defined in the system of the present disclosure.

It can be clearly understood by those skilled in the art that for the convenience and conciseness of description, the specific working process of the system, apparatus and unit described above can refer to the corresponding process in the aforementioned method embodiment, and will not be repeated here.

The apparatus embodiments described above are only schematic, where the units described as separate components may or may not be physically separated, and the components displayed as units may or may not be physical units; that is, they may be located in one place or distributed to multiple network units. Some or all of the modules can be selected according to actual needs to achieve the purpose of the solution of this embodiment. Those skilled in the art can understand and implement it without creative labor.

From the description of the above embodiments, those skilled in the art can clearly understand that each implementation can be implemented by means of software and necessary general hardware platform, and of course it can also be implemented by hardware. Based on this understanding, the essence of the above technical solution or the part that has contributed. to the prior art can be embodied in the form of a software product, and the computer software product can be stored in a computer-readable storage medium, such as a ROM/RAM, a magnetic disk, an optical disk, etc., and includes several instructions for making a computer device (which can be a personal computer, a server, or a network device, etc.) execute the method described in various embodiments or some parts of the embodiments.

Finally, it should be explained that the above embodiments are only used to illustrate the technical solution of the present disclosure, but not to limit it. Although the present disclosure has been described in detail with reference to the foregoing embodiments, it should be understood by those skilled in the art that it can still modify the technical solutions described in the foregoing embodiments or replace some technical features with equivalents. However, these modifications or substitutions do not make the essence of the corresponding technical solutions deviate from the spirit and scope of the technical solutions of various embodiments of the present disclosure.

1. An access processing method, comprising:
determining a corresponding storage node from a network storage system according to a file directory that a virtual machine requests to access;
creating a first virtual drive device in a physical host and controlling the first virtual drive device to connect with the storage node;
wherein the file directory is configured to be mounted to a target directory of the virtual machine through a second virtual drive device, so that the virtual machine accesses the file directory from the storage node through the target directory based on the first virtual drive device and the second virtual drive device; the second virtual drive device corresponding to the first virtual drive device is created in the virtual machine and synchronously obtains the file directory from the first virtual drive device.

2. The method according to claim 1, wherein the determining a corresponding storage node from a network storage system according to a file directory that a virtual machine requests to access comprises:
determining the corresponding storage node from the network storage system according to the file directory contained in a virtual machine creation request; the virtual machine creation request is configured to create a corresponding virtual machine in the physical host.

3. The method according to claim 1, wherein the determining a corresponding storage node from a network storage system according to a file directory that a virtual machine requests to access comprises:
seeking whether there is a storage node providing the file directory from the network storage system according to the file directory that the virtual machine requests to access;
if yes, acquiring a storage address of the storage node;
if not, selecting any storage node to create the file directory and acquiring a storage address of the storage node;
wherein the storage address is configured to indicate that the first virtual drive device connects to the corresponding storage node.

4. The method according to claim 1, wherein the creating a first virtual drive device in a physical host comprises:
creating the first virtual drive device in a data processing unit DPU of the physical host.

5. An access processing method, comprising:
establishing a connection between a first virtual drive device and a storage node corresponding to a virtual machine in a network storage system, wherein the storage node is determined based on a file directory that the virtual machine requests to access;
synchronizing the file directory to a second virtual drive device, wherein the second virtual drive device corresponding to the first virtual drive device is created in the virtual machine; the file directory is configured to be mounted to a target directory of the virtual machine through the second virtual drive device;
accessing the file directory from the storage node based on an access request generated by the second virtual drive device;
wherein the access request is generated when the second virtual drive device receives an access instruction of the virtual machine; the access instruction is generated by the virtual machine based on an access operation on the target directory.

6. The method according to claim 5, wherein the establishing a connection between a first virtual drive device and a storage node corresponding to a virtual machine in a network storage system comprises:
establishing an RDMA connection with the storage node corresponding to the virtual machine in the network storage system;
the accessing the file directory from the storage node based on an access request generated by the second virtual drive device comprises:
generating an RDMA access message based on the access request generated by the second virtual drive device;
sending the RDMA access message to the network storage system to access the file directory in the storage node.

7. The method according to claim 5, wherein the accessing the file directory from the storage node based on an access request generated by the second virtual drive device comprises:
taking a shared memory applied by the second virtual drive device in the virtual machine as a data cache, and sending an access message to the storage node to access the file directory based on the access request generated by the second virtual drive device.

8. An access processing method, comprising:
creating, in a virtual machine, a second virtual drive device which corresponds to a first virtual drive device in a physical host, wherein the first virtual drive device is connected with a storage node corresponding to the virtual machine; the storage node is determined based on a file directory that the virtual machine requests to access;
mounting the second virtual drive device to mount the file directory synchronously obtained by the second virtual drive device from the first virtual drive device to a target directory;
detecting an access operation on the target directory;
sending an access instruction to the second virtual drive device, to access the file directory from the storage node by using the second virtual drive device and the first virtual drive device.

9. The method according to claim 8, wherein the creating, in a virtual machine, a second virtual drive device which corresponds to a first virtual drive device in a physical host comprises:
in response to a startup instruction, creating the corresponding second virtual drive device when the first virtual drive device is detected in the physical host.

10. (canceled)

11. (canceled)

12. (canceled)

13. (canceled)

14. A computer device comprising a processing component and a storage component, wherein the storage component stores one or more computer instructions; the one or more computer instructions are configured to be called and executed by the processing component, so as to run a storage client end to implement the access processing method according to claims 1;
wherein the processing component comprises at least one CPU and at least one DPU;
the at least one CPU is specifically configured to create and run a virtual machine, and create and run a second virtual drive device;
the at least one DPU is specifically configured to run the storage client end.

15. The computer device according to claim 14, wherein the one or more computer instructions are configured to be called and executed by the processing component, so as to run the storage client end to further implement the following operation:
determining the corresponding storage node from the network storage system according to the file directory contained in a virtual machine creation request; the virtual machine creation request is configured to create a corresponding virtual machine in the physical host.

16. The computer device according to claim 14, wherein the one or more computer instructions are configured to be called and executed by the processing component, so as to run the storage client end to further implement the following operation:
seeking whether there is a storage node providing the file directory from the network storage system according to the file directory that the virtual machine requests to access;
if yes, acquiring a storage address of the storage node;
if not, selecting any storage node to create the file directory and acquiring a storage address of the storage node;
wherein the storage address is configured to indicate that the first virtual drive device connects to the corresponding storage node.

17. The computer device according to claim 14, wherein the one or more computer instructions are configured to be called and executed by the processing component, so as to run the storage client end to further implement the following operation:
creating the first virtual drive device in a data processing unit DPU of the physical host.

18. A computer device comprising a processing component and a storage component, wherein the storage component stores one or more computer instructions; the one or more computer instructions are configured to be called and executed by the processing component, so as to create and run a first virtual drive device to implement the access processing method according to claim 5;
wherein the processing component comprises at least one CPU and at least one DPU;
the at least one CPU is specifically configured to create and run a virtual machine, and create and run a second virtual drive device;
the at least one DPU is specifically configured to run a storage client end.

19. The computer device according to claim 18, wherein the one or more computer instructions are configured to be called and executed by the processing component, so as to run the first virtual drive device to further implement the following operations:
establishing an RDMA connection with the storage node corresponding to the virtual machine in the network storage system;
generating an RDMA access message based on the access request generated by the second virtual drive device;
sending the RDMA access message to the network storage system to access the file directory in the storage node.

20. The computer device according to claim 18, wherein the one or more computer instructions are configured to be called and executed by the processing component, so as to run the first virtual drive device to further implement the following operations:
taking a shared memory applied by the second virtual drive device in the virtual machine as a data cache, and sending an access message to the storage node to access the file directory based on the access request generated by the second virtual drive device.

21. A computer device comprising a processing component and a storage component, wherein the storage component stores one or more computer instructions; the one or more computer instructions are configured to be called and executed by the processing component, so as to create and run a virtual machine to implement the access processing method according to claim 8;
wherein the processing component comprises at least one CPU and at least one DPU;
the at least one CPU is specifically configured to create and run the virtual machine, and create and run a second virtual drive device;
the at least one DPU is specifically configured to run a storage client end.

22. The computer device according to claim 21, wherein the one or more computer instructions are configured to be called and executed by the processing component, so as to run the virtual machine to further implement the following operations:
in response to a startup instruction, creating the corresponding second virtual drive device when the first virtual drive device is detected in the physical host.

23. A non-transitory computer-readable storage medium storing a computer program, wherein when the computer program is executed by a computer, the computer enables to implement the access processing method according to claim 1.
